(19) United States
(12) Patent Application Publication
(10) Pub. No.: US 2008/0192727 A1
(43) Pub. Date: Aug. 14, 2008

(54) Reconfiguration of Non-Fully Populated Switch Arrays

(75) Inventors: Jordan Pesusich, Brighton, CO (US); Gary Long, Loveland, CO (US)

Correspondence Address: KRAJEC PATENT OFFICES, LLC, 820 WELCH AVENUE, BERTHOUD, CO, 80513, US

(73) Assignee: Remote Switch Systems, Loveland, CO (US)

(21) Appl. No.: 11/673,009

(22) Filed: Feb. 9, 2007

(51) Int. Cl. H04L 12/28

(52) U.S. Cl. 370/351

(57) ABSTRACT

A system and method for configuring non-fully populated switch matrixes by identifying the initial configuration, developing a transition sequence, and executing the transition sequence. The transition sequence may include reconfiguring an existing connection by first making a bridge connection then breaking the original connection, prior to adding an additional connection. In some situations, one or more intermediate configurations may be used to transition from one configuration to another. Some configurations may free certain areas of a switch matrix for maintenance such as hot swapping printed circuit cards.

### BACKGROUND

a. Field

The present invention pertains generally to switching devices and specifically to the operation of switching devices having less than a fully populated switch matrix.

b. Description of the Background

Switch devices are used in telephony and other networks for connecting many inputs to many outputs. Such devices may be capable of connecting 500 or more input lines to 500 or more output lines. In some cases, several thousand input and output lines may be switched.

Many switch devices have a less than fully populated switch matrix. In a fully populated matrix with 500 inputs switchable to any of 500 outputs, 250,000 relays or contacts would be needed. Such a switch matrix would be extremely expensive and prone to dead lines should a relay become inoperative. Alternative switch matrices have been developed that use far fewer switch contacts and have several routes available for each connection. One example of such a matrix is described in U.S. patent application Ser. No. 10/205,678 and publication 2004/0017805 entitled “Intelligent Cross Connect” by Robert Smith and Gary Long, the entire contents of which are hereby specifically incorporated by reference.

Non-fully populated arrays generally require two or more relay contacts or switch elements to be made to establish a connection. Further, there may be several different routes for a signal path to travel, with some routes being more optimal than others. Such routes may be selected, for example, to bypass a specific switch element that is known to be inoperable.

### SUMMARY

A cross-connect switch system may be managed by rerouting connection paths using a make-then-break rerouting method. Connections within a switch may be changed by determining a new switch configuration, moving existing connections to new paths using a make-then-break rerouting method, and adding new connections. Connections may be optimized for various factors, such as power consumption or performance. The method may also be used to move connection paths off of a replaceable card within the cross-connect switch so that the card may be replaced keeping the connection paths active.

### BRIEF DESCRIPTION OF THE DRAWINGS

In the drawings,

FIG. 1 is a diagrammatic illustration of an embodiment showing a system for controlling a cross connect switch.

FIG. 2 is a diagrammatic illustration of an embodiment showing the optimization of a switch device configuration.

FIG. 3 is a flowchart illustration of an embodiment of a method for changing a switch device.

FIG. 4 is a diagrammatic illustration of an embodiment showing a switch device with removable cards.

FIG. 5 is a flowchart illustration of an embodiment of a method for replacing a switch matrix card.

### DETAILED DESCRIPTION

Specific embodiments of the invention are described in detail below. The embodiments were selected to illustrate various features of the invention, but should not be considered to limit the invention to the embodiments described, as the invention is susceptible to various modifications and alternative forms. The invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the invention is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

For the purposes of this specification, the following phrases shall be used as follows. A “switch element” refers to a single contact capable of closing or opening to conduct a signal. In some embodiments, the single contact may be a double throw contact wherein two signals are conducted in parallel. A switch element may be a transistor, relay, fiber optic switch, FET, valve, or any other element capable of opening and closing a conductive path.

A “switch array” refers to a group of switch elements arranged to provide several options for conducting one or more signals along several different conducting paths. In some cases, a switch array may be arranged in a crossbar fashion so that any input may be conducted to any output.

A “switch matrix” refers to an arrangement of switch elements that enables many inputs to be individually connected to many outputs. In many cases, the switch matrix may be comprised of many switch arrays. The switch matrix comprises the internal switch elements and conductors required to make the required connections.

A “switch device” refers to a switch matrix that has a controller, enclosure, and interfaces to the outside world. A switch device may be a component in a network system.

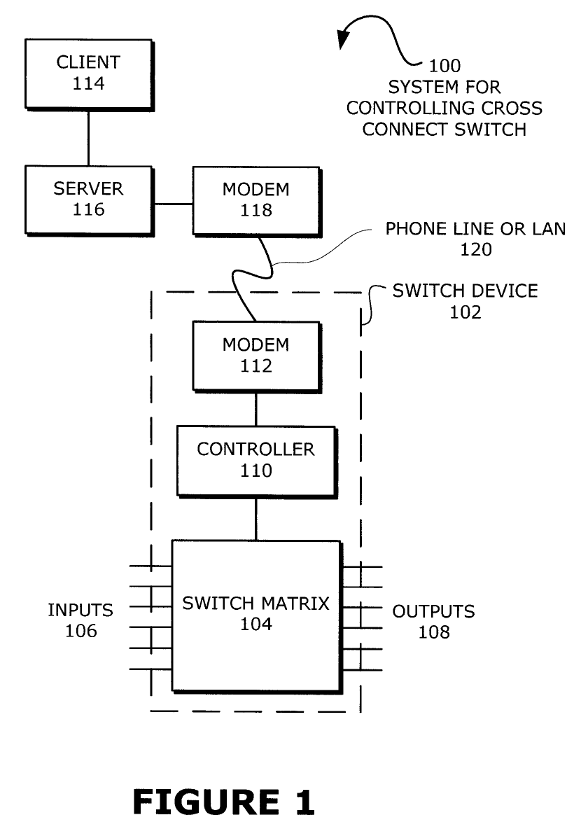

FIG. 1 illustrates an embodiment 100 showing a system for controlling a cross connect switch matrix. The switch device 102 contains a switch matrix 104 that connects many inputs 106 to many outputs 108. The device 102 also contains a controller 110 and a modem 112. A client device 114 may communicate with a controller 116 to determine commands for the switch device 102. The commands are transmitted using a modem 118 through a phone line or local area network (LAN) 120 to the modem 112.

The embodiment 100 is an example of an interconnect system useful for connecting various elements of a communications network. For example, the switch device 102 may be a part of a private branch exchange (PBX) system for connecting telephones and data communications within a building, company, or organization. The device 102 may be located in a telephone company's central office and used to connect various local lines with long distance communications lines. In other examples, the device 102 may connect various fiber optic network connections or it may connect many sensors and data collection devices.

In some embodiments, the switch matrix 104 may use relays or other switch elements to make various connections between inputs and outputs. For example, a classic magnetic relay connection may be preferred for switching high frequency data lines, while FET technology may be preferred for switching low frequency voice-only lines. Various fiber optic switch elements may also be used to provide continuity between an input and output. Coaxial cable, twisted pair cable, thermocouple cable, single connections, or any other conductor of analog or digital signals may be switched by the switch matrix 104, depending on the precise embodiment.

The embodiment 100 is an example of a controllable switch matrix. A client computer 114 may perform various diagnostic and control functions on the switch matrix 104. The client 114 may have two way communication with the controller 110 and may be able to determine the current configuration, status, performance, and other data about the switch device 102. In a typical use, a technician may use the client 114 to request specific input lines 106 be connected or disconnected with specific output lines 108.

The client 114 may be operated remotely, such as from a central maintenance and control facility, from a portable terminal device connected to the internet, or from any other interactive device. Similarly, the server 116 may be a dedicated server computer at a network operations facility that handles one or more switch devices 102. In some embodiments, the functions of the server 116 may be performed by software operable on the controller 110 within the switch device 102. In such embodiments, the client 114 may interface directly with the controller 110 that performs the functions of the server 116.

The communications between the server 116 and the controller 110 are illustrated in the present embodiment as using modems 112 and 118. In other embodiments, the server 116 and controller 110 may communicate using Ethernet, wireless, or any other communications medium, including proprietary and standardized protocols.

The embodiment 100 is one example of an architecture of a controllable switch matrix that contains at least one computational device and a user interface. Input from the user interface, in this embodiment the client 114, can be used by the server 116 or controller 10 to determine the proper settings for the switch matrix 104. In some cases, a majority of the computation will be performed by controller 110 and very little, if any, by the server 116, while in other cases the opposite may be true. Those skilled in the arts may elect to perform certain computations in the server 116 and other computation in the controller 10, depending on the precise implementation. In still other cases, the functions of the server 116 may be incorporated in the controller 110, while in other cases many or all of the functions of the controller 110 may be incorporated into the server 116.

For the purposes of this specification, the functions relating to the operation and control of the switch matrix 104 may be performed by either or a combination of the server 116 and/or the controller 110.

The switch matrix 104 may connect various inputs 106 to various outputs 108. In many cases, the switch matrix 104 may be an any-to-any switch, configurable to connect any input to any output. In other cases, the switch matrix 104 may be adaptable to connect a range of inputs to a range of outputs. For example, a switch matrix may be designed to connect any input or output to any other input or output. Other switch matrix designs may be more restricted in the allowable connection paths and only permit a range of inputs to connect to a range of outputs.

Many designs for a switch matrix 104 contain a less than fully populated switch matrix. A fully populated switch matrix would contain one relay or switch element on each line for every possible connection of the switch matrix. For example, a fully populated switch matrix having 100 inputs and 100 outputs would contain 100×100 or 10,000 switches or relays. In order to make a connection between an input and an output, only one switch element would be closed. In a non-fully populated switch matrix, the switch elements may be grouped together in hierarchical or other structures so that 100 inputs may be still connected to 100 outputs, but with far fewer than 10,000 switch elements or relays. In many cases, the number of switch elements may be an order of magnitude lower for a non-fully populated switch matrix. In such non-fully populated switch matrixes, each connection may require the activation of several switch elements or relays to complete a connection. Additionally, there may be several routes for any given connection.

When many routes exist for a given connection, there may be situations where existing connections may limit the path choices for a new connection. Additionally, when many routes exist for a connection, inoperable switch elements or underperforming circuits within the switch matrix may be selectively avoided. Such situations may create difficulties in setting the switch matrix 104 to a configuration that connects all of the required inputs to the specific outputs.

As a switch matrix 104 makes additional connections, the switch matrix may become saturated and severely limit the path routes available for making additional connections. In some cases, a new connection may require that an existing path be moved to an alternative routing so that the new connection may use one or more of the switch elements used by the existing path. In such a case, the existing connection may be made using a new path through the switch matrix, then the previous path would be severed. By using a make-then-break sequence, the existing connection may be preserved while freeing up space for a new connection. After the first connection is moved to a new route, the second connection may be completed.

The ability to reroute existing paths within a switch matrix may have several uses. For example, the path routing within a switch matrix may be optimized for various parameters. In another example, certain areas of the switch matrix may be freed up so that repairs or replacements may be made while connections are still active. In such an example, the connections made across a replaceable card may be moved to other cards so that the replaceable card may be ‘hot-swapped’ by a technician.

In some embodiments, a configuration optimization sequence may be executed by the controller 110, while in other embodiments, such a sequence may be executed by the server 116 or even the client 114. In still other embodiments, certain portions of a configuration optimization may be performed by one computational device and other portions performed by a second computational device.

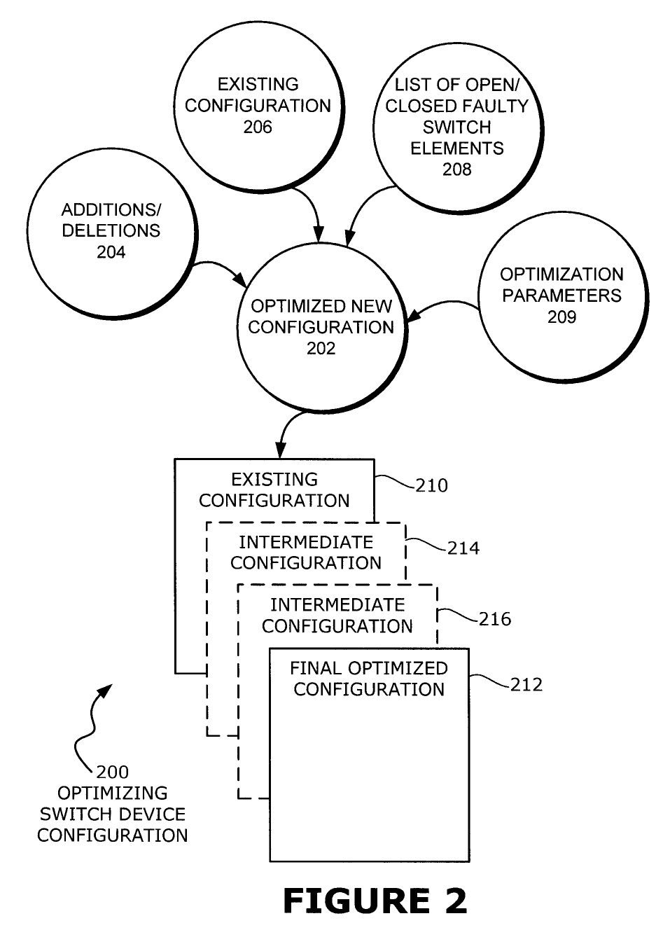

FIG. 2 illustrates an embodiment 200 of a process for optimizing a switch configuration. An optimized new configuration 202 is comprised of additions and deletions 204, the existing configuration 206, a list of open or closed faulty switch elements 208, and some optimization parameters 209. From the optimized configuration 202, the existing configuration 210 and the final configuration 212 are defined. Additionally, one or more intermediate configurations 214 and 216 may also be defined.

The optimized configuration 212 may include input from several sources to operate a switch device in an optimal state. In some situations, the optimal state may merely be that every required connection between an input and an output is made, regardless of the circuitous route of the connection. In other situations, the optimal state may be to disperse the routes throughout the switch matrix so that heat buildup is minimized or power consumption is lessened. Various optimization criteria may be employed in combination with other criteria, depending on the precise embodiment contemplated.

A switch matrix may be configured in several successive configurations to move certain connections to different paths. Intermediate configurations may be used when a connection path is moved to an intermediate path in the process of optimizing all of the connection paths through the switch matrix. In some situations, no intermediate configurations may be used, while in other situations, many successive intermediate configurations may be used.

By optimizing the configuration of a switch matrix, the performance of the switch matrix and/or the performance of the communications transmitted through the switch matrix may be optimized. For example, the switch matrix performance may be optimized by distributing the power usage within the switch matrix to heat build up in a local area. The performance of the communications transmitted through the switch matrix may be optimized by separating signals that may likely interfere, such as high speed data signals or any other type of performance sensitive data signals.

The optimization process may take into account that some connection paths are different from others and thus may be optimized using different parameters or priorities. For example, a switch matrix used for telecom applications may handle POTS voice lines in addition to T1 data lines. The T1 data lines may have restrictive requirements for separation between adjacent conductors of a T1 connection, while the POTS voice lines may not have such a restriction. Within an optimization routine for such an embodiment, the T1 data lines may be optimized for spacing and separation first, and then the POTS lines may be optimized within the remaining path options for a different optimization parameter.

In selecting routes for communications paths, the optimization routine may use a list of faulty switch elements within the switch matrix to select paths that avoid such switch elements. For example, if a relay contact is stuck in the open position, the routing and optimization algorithm may avoid using that relay. In another example, if a relay contact is stuck in the closed position, the routing and optimization algorithm may use the relay contact as a last resort, when no other routing options are available. In some cases, a switch matrix may include passive components that perform filtering, buffering, or other functions. If such passive components are known to be underperforming, those connections may be avoided or may be used for connections that have lower performance needs than other connections.

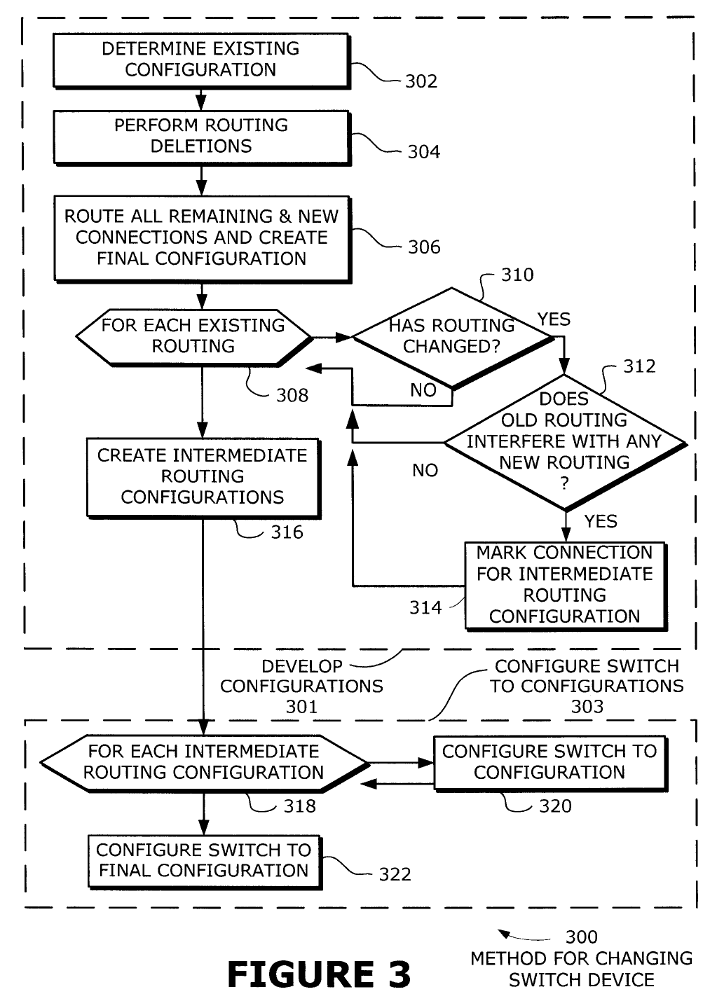

FIG. 3 illustrates an embodiment 300 of a method for changing a switch matrix. The switch configurations are defined in the first set of steps 301, and the switch matrix is set to the configurations in the second set of steps 303. The existing configuration is determined in block 302, and any deletions from the routing are performed in block 304. All remaining and new connections are routed and optimized in block 306, which also includes creating the final configuration. For each existing routing path in block 308, if the routing has not changed in block 310, the next path is evaluated in block 308. If the path has changed in block 310 and the old routing interfered with any new routing in block 312, then the connection path is marked for intermediate routing configuration in block 314. The intermediate configuration is created in block 316. In some cases, multiple intermediate configurations may be necessary.

For each intermediate routing configuration in block 318, the switch matrix is configured to that configuration in block 320. After all the intermediate configurations are performed in block 318, the switch is set to the final configuration in block 322.

Embodiment 300 illustrates one method for changing the configuration of a switch matrix from a current setting to a final setting. Some routing paths within the switch matrix may be deleted, some may be repositioned, and others may be added. The final configuration of the switch matrix may be optimized using any parameters, rules, or methodology one skilled in the art may select. When an existing routing interferes with a new connection, the existing routing is moved using an intermediate configuration setting and a make-then-break method for establishing a new routing. Each intermediate configuration may contain a step in the make-then-break process.

In some embodiments, the steps for developing configurations 301 may be performed by an optimization routine operable on a server computer. The configurations may then be transmitted to the switch device for executing in the steps for configuring the switch 303. In other embodiments, all of the steps of embodiment 300 may be performed by a controller attached to or operated within the switch device.

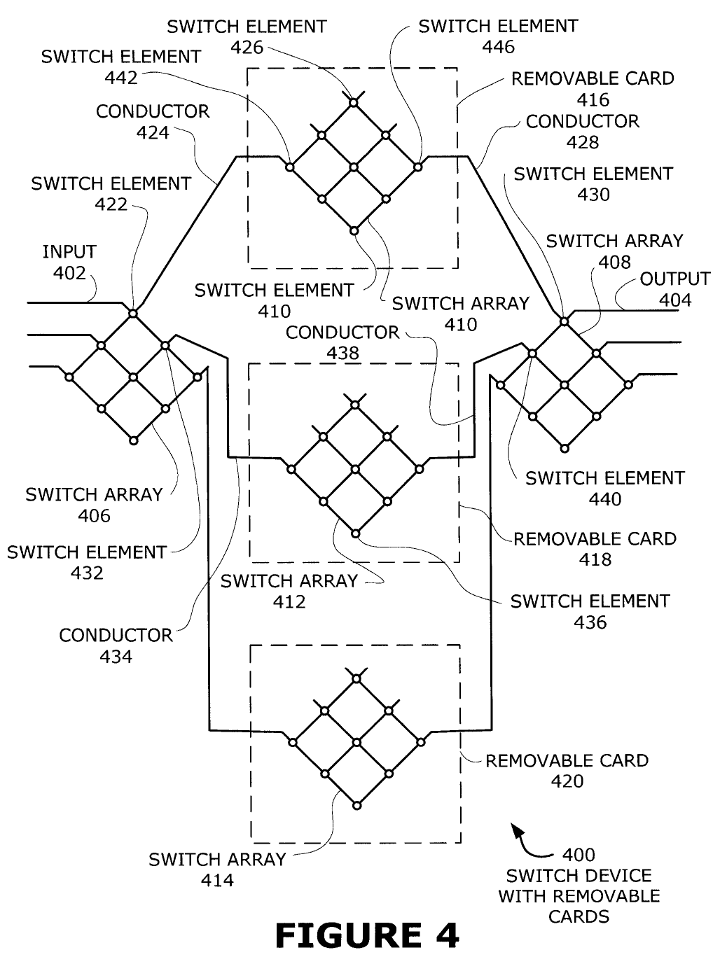

FIG. 4 illustrates an embodiment 400 of a switch device with removable cards. In order to illustrate the operation of a non-fully populated switch device, only a portion of such a device is shown. Input 402 and output 404 are connected to switch arrays 406 and 408, respectively. Switch arrays 406 and 408 are connected to switch arrays 410, 412, and 414, which are on separately removable cards 416, 418, and 420, respectively.

Switch array 406 enables input 402 to be directed to any of the central switch arrays 410, 412, or 414. When switch element 422 is closed, the input 402 is connected to the conductor 424 to the switch array 410. By closing switch element 426, the signal conducts through conductor 428 to the switch element 430 and the output 404.

Similarly, when switch element 432 is closed, conductor 434 connects to the switch array 412, where switch element 436 may be closed to conduct through conductor 438 to switch element 440 and output 404.

The embodiment 400 illustrates one architecture for a non-fully populated switch matrix and used to illustrate the operation of an embodiment. Other switch matrix designs may be selected by those skilled in the art for a particular application. Larger switch matrixes may incorporate several layers of switch arrays, or may arrange switching elements in different manners, other than in discrete arrays as shown.

The embodiment 400 illustrates a switch matrix wherein each connection of an input and output may take multiple routes. For example, the illustrated connection may pass through the switch array 410 or switch array 412. An additional path may be through switch array 414.

A decision to select one or another of the connection paths may be made based on various optimizing criteria. For example, if a high frequency data line is routed through switch matrix 410, the connection path through switch matrix 412 may be selected to minimize any interference. Similarly, if the switch element 426 were stuck open, the connection path through switch matrix 412 may be selected.

In some situations, a more circuitous path may be found. Using the example of switch element 426 being stuck open, switch elements 442, 444, and 446 may be closed to provide a path around switch element 426. However, when this path is selected, it may preclude other connections from being made.

For example, assume that a first connection path from input 402 to output 404 follows the path through switch elements 422, 442, 444, 446, and 430. If a second connection path is added to the switch matrix and the second path needed to use one or more of the switch elements 442, 444, or 446 in switch array 410, an intermediate configuration may make a parallel path by closing switch elements 432, 436, and 438. A subsequent intermediate configuration may open the switch elements 422, 442, 444, 446, and 430. A final configuration may close the necessary switch elements in switch array 410 to make the second connection.

In such an example, the connectivity of input 402 and output 404 is maintained while the connection path is moved to a different location within the switch matrix. In some cases, some noise may be introduced into the signal path, depending on the signals, conductors, and the specific switch elements selected, among other factors. In other cases, the signal may experience only insignificant effects by changing paths within the switch matrix.

In another example, the signal path from input 402 to output 404 may be moved from switch matrix 410 to switch matrix 412 so that the switch matrix 410, located on the removable card 416, may be removed and replaced. In such an example, maintenance may be performed by ‘hot swapping’ the removable card 416 while the remaining portions of the overall switch device are still functional. In some embodiments, an amount of redundancy may be built into the hardware and placed on separate hot swappable components so that periodic maintenance may be performed while the switch device is fully functional.

In some situations where a hot swap is to be performed on one or more of the removable cards 416, 418, or 420, a technician may indicate to the switch device that a hot swap is to be performed. In some embodiments, a card may have a user activated button that signals a controller in the switch device to free up the card for replacement. The card may have a color coded light or other indicator to signal the technician when the connections have been moved from the card and that the card is free to be removed. After installing a replacement card, the technician may indicate to the switch device that the card is able to be used. Such an indication may be made by pressing a button on the replaced card, entering a key sequence on a keypad or other interface device, or using a remote client connected to the switch device controller.

In some situations, it may be necessary to drop some connections to perform a hot swap of one or more of the removable cards 416, 418, or 420. When moving connections off of a card in preparation for hot swapping, some connections may have a higher priority than other connections. In such a case, the higher priority connections may be preserved at the expense of lower priority connections. For a telecom example, a T1 data line connection may be preserved even if a POTS voice line must be dropped. In some cases, a higher priority may be placed on certain connections within a type of connection. For example, some POTS lines may have a higher priority than other POTS lines that may be dropped to preserve the higher priority connections.

Various switch matrix architectures may be created that enable hot swapping of various components. In some architectures, a redundant amount of switching may be incorporated into the switch matrix so that paths may be rerouted even when fully utilized without having to drop connections. Such an architecture may be useful when very high uptime is required, but it may also add some additional cost to the switch device.

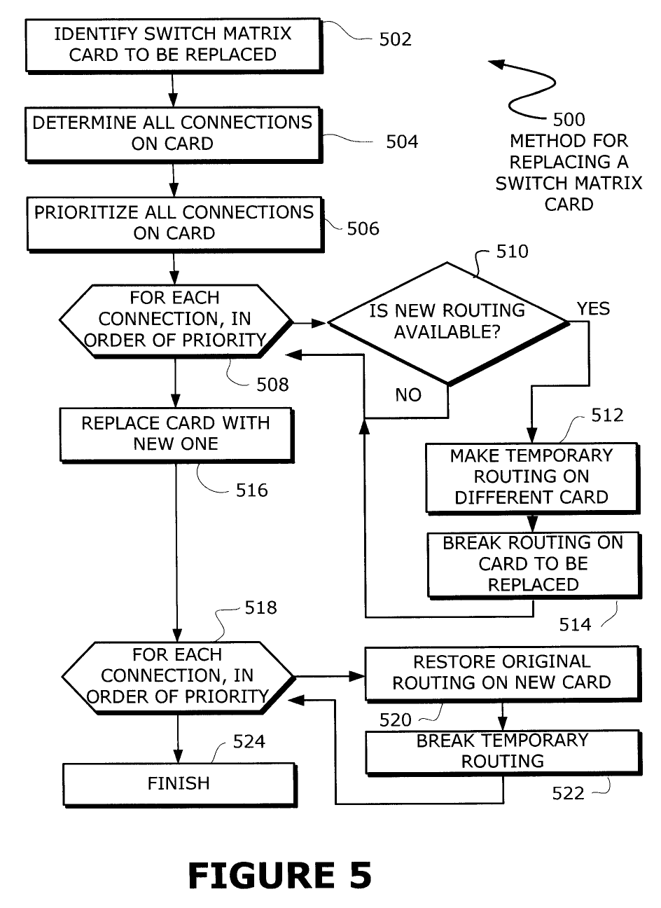

FIG. 5 is a flowchart illustration of an embodiment 500 of a method for replacing a card within a switch matrix. The switch matrix card to be replaced is identified in block 502. All of the connections on the card are identified in block 504 and they are prioritized in block 506. For each connection in order of priority in block 508, if new routing is available in block 510, the new routing is made onto a different card in block 512 and the old routing is broken in block 514. If a new routing is not available in block 510, the routing is skipped and will be lost when the card is taken offline. The old card is replaced with a new card in block 516, and for each re-routed connection in block 518, it is restored onto the new card in block 520 and the temporary routing is broken in block 522. The process ends in block 524.

Embodiment 500 illustrates a method for moving connections off of a designated area of a switch matrix so that maintenance may be performed on the area. In many cases, the area may be an entire replaceable card. In other cases, it may be an area having components that require other types of service. After identifying and prioritizing the connections within the area, the connection paths are rerouted to other areas of the switch matrix using a make-then-break sequence, thus preserving continuity. After the area is serviced by replacing a card or other service, the connection paths may be moved back.

In some embodiments, the rerouted connection paths may be left in the position determined in block 512 and the sequence may end at block 516. In some situations, only a certain subset of connections may be moved back in the sequence of blocks 518, 520, and 522. For example, those connections that were not able to be temporarily routed in the sequence of blocks 510, 512, and 514 may be restored but those moved from their original location may be left alone. In other embodiments, the connections moved in blocks 518, 520, and 522 may be the result of a configuration optimization process such as those described above.

The connections to be moved are done so on the basis of priority in block 508. The highest priority connections are attempted to be moved first, which may use up connection resources. Thus, lower priority connections may not be able to be connected prior to removing or repairing the hardware in block 516. In some situations, connections using other areas of the switch matrix may be rearranged or prioritized to allow room for high priority connections of block 508 to be routed. Using a telecom example, rerouting a high priority T1 line in block 510 may cause a lower priority POTS voice line to be dropped elsewhere in the switch matrix to allow room for the T1 line to be routed in block 512.

Non-fully populated switch matrixes often have the ability to route connections through several different paths. By using various optimization routines, the connections may be optimized for better overall performance of the switch device as well as better performance for some or all of the connections made with the switch device. Connections may be moved from one routing to another routing by using a make-then-break sequence so that continuity is preserved for the connection. The same process may also be used to clear a certain area of a switch device of connections so that service may be performed. Such service may include hot swapping printed circuit cards for the affected areas.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A non-fully populated switch comprising:
a plurality of addressable devices operable to open or close connections and arranged to enable multiple routes of electrical connections from substantially any of a plurality of inputs to substantially any of a plurality of outputs, said plurality of addressable devices being configured in a first configuration having a first connection defined by a first routing;
a controller adapted to change said addressable devices into a second configuration comprising a second connection and said first connection, with said first connection comprising a second routing, and change from said first configuration to said second configuration by a method comprising making said second routing functional in parallel to said first routing prior to severing said first routing.

2. The switch of claim 1 wherein said plurality of inputs are telephony connections.

3. The switch of claim 1 wherein said plurality of inputs are data connections.

4. The switch of claim 1 wherein said plurality of inputs are electrical wired connections.

5. The switch of claim 1 wherein said plurality of inputs are fiber optic connections.

6. The switch of claim 1 wherein said controller is further adapted to optimize said second configuration.

7. The switch of claim 1 further comprising and input adapted to receive a command from a remote device, said remote device adapted to optimize said second configuration.

8. A switch device comprising:
a plurality of inputs and outputs;
a plurality of switch elements adapted to create routes for substantially any of said inputs to substantially any of said outputs, wherein each of said routes is selected from a plurality of routing options for a connection between a specific input to a specific output;
a plurality of removable cards, each of said removable cards comprising a subset of said switch elements;
a controller adapted to identify a first removable card to be replaced, identify a first route that uses said switch elements on said first removable card, reroute said first route to a second removable card by first making a second route on said second removable card, then breaking said first route, said controller further adapted to indicate that said first removable card is ready to be replaced.

9. The switch device of claim 8 wherein said controller is further adapted to identify a third route that uses the switch elements on said first removable card, determine a priority for said first route and said third route, and selecting said first route for rerouting and not selecting said third route for rerouting.

10. The switch device of claim 8 further comprising a switch on said first removable card adapted to be activated by a technician to identify said first removable card to said controller for removal.

11. The switch device of claim 8 wherein said switch elements comprise relay contacts.

12. The switch device of claim 8 wherein said switch elements comprise FET devices.

13. The switch device of claim 8 wherein each of said plurality of inputs comprises a tip and ring conductor.

14. The switch device of claim 8 wherein said switches comprise fiber optic switches.

15. A method comprising:
identifying a first removable card in a switch device, said switch device having a plurality of inputs and outputs, a plurality of switch elements adapted to create routes for substantially any of said inputs to substantially any of said outputs, wherein each of said routes is selected from a plurality of routing options for a connection between a specific input to a specific output, and a plurality of removable cards, each of said removable cards comprising a subset of said switch elements;
identifying a first route that uses said switch elements on said first removable card;
rerouting said first route to a second removable card by first making a second route on said second removable card, then breaking said first route; and
indicating that said first removable card is ready to be replaced.

16. The method of claim 15 further comprising:
identifying a third route that uses the switch elements on said first removable card;
determining a priority for said first route and said third route; and
selecting said first route for rerouting and not selecting said third route for rerouting.

17. The method of claim 15 further comprising:
activating a manual switch on said first removable card by a technician to identify said first removable card for removal.

18. The method of claim 15 wherein said switch elements comprise relay contacts.

19. The method of claim 15 wherein said switch elements comprise FET devices.

20. The method of claim 15 wherein each of said plurality of inputs comprises a tip and ring conductor.
